(19) United States
(12) Patent Application Publication
(10) Pub. No.: US 2014/0114816 A1
(43) Pub. Date: Apr. 24, 2014

(54) MULTIDIMENSIONAL MEASUREMENT BASIS FOR ACCOUNTING SYSTEMS

(71) Applicant: MICROSOFT CORPORATION, Redmond, WA (US)

(72) Inventors: Arthur Greef, Seattle, WA (US); Michael Gall, Copenhagen (DK); Xavier Chapé, Stenlose (DK); John Healy, Fargo, ND (US); Manoj Swaminathan, Issaquah, WA (US); Pär Åkerblom, North Bend, WA (US)

(73) Assignee: MICROSOFT CORPORATION, Redmond, WA (US)

(21) Appl. No.: 13/656,325

(22) Filed: Oct. 19, 2012

(51) Int. Cl. G06Q 40/00

(52) U.S. Cl. CPC G06Q 40/10
USPC 705/30

(57) ABSTRACT

Techniques to provide a multi-measurement basis for accounting systems are described. A technique may include receiving data from a source document, documenting the received data as base multidimensional measurements that characterize an event, calculating derived multidimensional measurements that quantify the social, operational, and financial consequences of the event from the base multidimensional measurements. Derived measurements are linked to base measurements in measurement chains. Events that are related causally may be linked together in event chains. The measurement chains and event chains may be used to generate subledger journal entries, which may in turn be used to generate general ledger journal entries. An event may capture information about an event beyond what may be reflected in the source document. Other embodiments are described and claimed.

### BACKGROUND

A traditional accounting system processes source documents to generate detailed subsidiary journal account entries and summarized general ledger account entries. Source documents such as, but not limited to, purchase orders, receiving reports, vendor invoices and vendor payments document measurements using single quantity dimensions such as a purchase quantity in boxes, a purchase unit price in dollars per unit, and so forth. These measurements may then be transferred to the subledger journal accounts in recognition of the event. Subledger journal entries may be transferred to single dimension general ledger account entries. There can be many subsidiary journals in an accounting system. Each journal can use specialized accounts. For example, a cost journal could use cost accounts, and a purchase journal could use purchase accounts for each vendor. The various source documents use different measurement bases and may not capture all of the dimensions of the components of a transaction. It is with respect to these and other considerations that the present improvements have been needed.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques to provide a multidimensional measurement basis for accounting systems. Some embodiments are particularly directed to techniques to provide a multidimensional measurement basis for accounting systems that are independent of accounting system implementation. In one embodiment, for example, a technique may include receiving data from a source document, documenting the received data as base multidimensional measurements that characterize an event, calculating derived multidimensional measurements that quantify the consequences of the event from the base multidimensional measurements. Base measurements and derived measurements are related in measurement chains. Events that are related causally may be linked together in event chains. The measurement chains and event chains may be used to generate subledger journal entries, which may in turn be used to generate general ledger journal entries. An event may capture information about an event beyond what may be reflected in the source document, for example, information related to the internal operational structure and internal operational processes of an organization. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system to provide a multidimensional measurement basis to an accounting system.

FIG. 2 illustrates a block diagram representing an embodiment of an operation of the system of FIG. 1.

FIG. 3 illustrates an embodiment of a measurement chain.

FIG. 4 illustrates an embodiment of an event chain.

FIG. 5 illustrates an example of an operation of the system of FIG. 1.

FIG. 6 illustrates an additional example of an operation of the system of FIG. 1.

FIG. 7 illustrates an additional example of an operation of the system of FIG. 1.

FIG. 8 illustrates an embodiment of a centralized system for the system of FIG. 1.

FIG. 9 illustrates an embodiment of a distributed system for the system of FIG. 1.

FIG. 10 illustrates an embodiment of a logic flow for the system of FIG. 1.

FIG. 11 illustrates an embodiment of a computing architecture.

FIG. 12 illustrates an embodiment of a communications architecture.

### DETAILED DESCRIPTION

Conventional accounting systems present various limitations. For example, conventional accounting systems typically do not have a common measurement basis that can be used from source documents through subsidiary journal entries and general ledger entries. This usually prevents code reuse, and increases the complexity of their solutions.

Another limitation of conventional accounting systems is that measurements may be documented on a source document but the measurements are characterized using only one dimension—the dimension that characterizes the magnitude of a measurement. For example, a purchase order line may list a product quantity measurement with “kg” for the weight dimension, and it may list a unit price per kg with “$/kg” for the price dimension. This solution requires more code when other dimensions of a measurement are required, for example, the person or organization that owns the product quantity, the location of the product quantity, the person or organization that offers the unit price, the date and time of the offer etc. This may increase complexity and decrease code reuse.

Another limitation of conventional accounting systems is that they typically record the value of an event, such as a purchasing event, in journal and ledger accounts using only one dimension—typically, the dimension that characterizes the magnitude of a currency value measurement. This presents a challenge to meeting various governmental statistical reporting requirements, because statistical reports usually require other measurements, e.g. economic, demographic, and operational measurements, such as the number of unemployed people per reporting period, the population per reporting period, the number of employees per reporting period, and so forth.

Another limitation is that conventional accounting systems sometimes add a list of financial dimensions to source document lines, as well as to journal and ledger accounts. However, the financial dimensions may not be part of a common measurement framework that combines magnitude and multidimensional units of measure, and they are only the dimensions for financial performance measurement. The result may be that operational dimensions such as location, activity, resource, date, resource controlling organization and resource owning organization are not part of the source document measurement dimensions. When operational dimensions are not included in the source document measurement dimensions, the code to calculate other measurements, such as cost measurements, is more complex and reuse is reduced.

To address these and other limitations, various embodiments are directed to techniques and systems for a multidimensional measurement basis in an accounting system. Embodiments may capture data entered for various source documents, e.g. purchase orders, invoices, and so forth. One or more events related to the transaction may be generated. The documentation of the event may include the data captured by the document as well as derived measurements that quantify consequences of the event. Measurements can be linked together into chains of bases and derived measurements. Events can be linked together into chains of causal events and effect events, independently of the implementation of the accounting system that consumes the data. Data from the measurement chains and event chains may be used to populate subledgers and general ledgers in accordance with various business and/or accounting system rules. As such, multidimensional measurements for quantifying the multidimensional operational, managerial and financial consequences of events may be captured and made available to an accounting system. Further, the use of measurement chains and event chains, and the multidimensional measurements may facilitate the generation of multidimensional subledger journal and general ledger account entries that characterize both the operational and financial consequences of events. As a result, the embodiments can improve affordability, scalability, modularity, extendibility, or interoperability for an operator, device or network.

With general reference to notations and nomenclature used herein, the detailed descriptions which follow may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the specific purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the desired method steps. The structure needed for a variety of these machines will appear from the description given.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives consistent with the claimed subject matter.

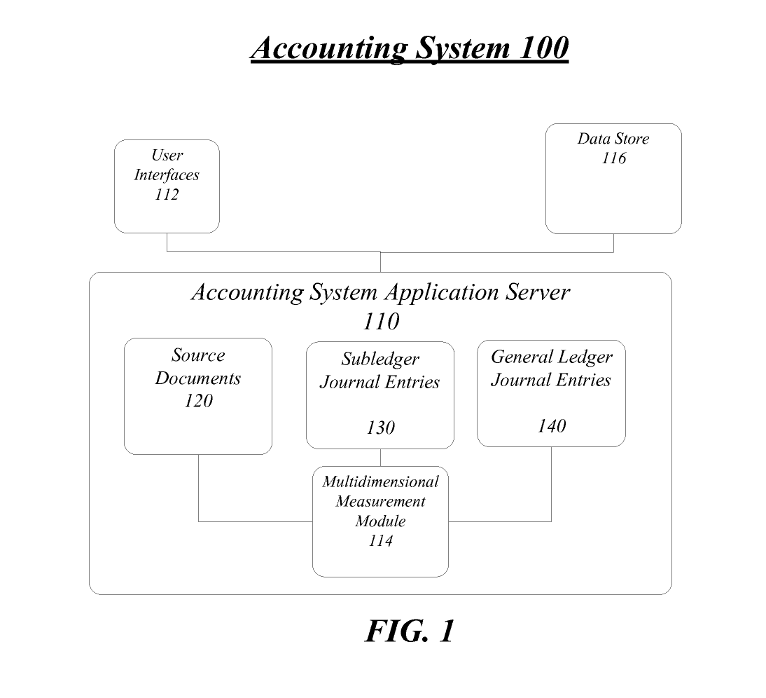

FIG. 1 illustrates a block diagram for an accounting system 100. In one embodiment, the accounting system 100 may comprise a computer-implemented accounting system 100 having an accounting system application server 110 comprising one or more components, such as multidimensional measurement module 114. Although the accounting system 100 shown in FIG. 1 has a limited number of elements in a certain topology, it may be appreciated that the accounting system 100 may include more or less elements in alternate topologies as desired for a given implementation.

The accounting system 100 may comprise accounting system application server 110. Accounting system application server 110 may be generally arranged to provide accounting system features, such as, but not limited to, receiving, generating, analyzing and storing accounting related data such as, but not limited to, inventory data, pricing data, invoicing data, accounts payable and accounts receivable data, purchase order data, business assets data, employee data and so forth. Accounting system 100 may provide one or more user interfaces 112 for users to enter accounting data, view accounting data, analyze accounting data, and output accounting data.

In an embodiment, accounting system application server 110 may execute on one or more computing devices on premises for an organization, such as a business enterprise. In another embodiment, accounting system application server 110 may be provided as a cloud-hosted application to an organization, and may therefore execute on one or more computing devices off-premises from the organization, but may appear to operate as though accounting system application server 110 were a locally installed on-premises application.

Accounting system application server 110 may generate and/or read from source documents, such as source document 120. A source document 120 may represent a paper form used in historical accounting systems but in electronic format. Examples of source documents 120 may include, without limitation, a purchase order, an invoice, a receipt, a shipping order, a receiving report, a payment, and so forth. A source document 120 documents the social, operational, and financial consequences of an accounting event. For example, a purchase order document documents the social, operational, and financial consequences of a purchase event.

A source document 120 may be provided from within accounting system 100, for example, through a document entry user interface 112 that provides fields that a user may fill in with data relevant to the event or document. A source document 120 may be provided externally to accounting system application server 110, for example, via a web-browser enabled form that accepts the document data entered by a user and provides the document data to the accounting system application server 110 directly, or makes the data available for the accounting system application server 110 to access. The embodiments are not limited to these examples.

Accounting system 100 may include a data store 116. Data store 116 may be used to store data relevant to the accounting system, including data received from entries in source documents 120. Data store 116 may store the data, for example, in tables, databases, lists, text files, or any other data format suitable for the accounting system 100.

Accounting system application server 110 may use data from source documents 120 for events and measurements to generate entries for various subledger journal entries 130. Subledger journal entries 130 may include, for example and without limitation, fixed assets journals, cost journals, purchase journals and so forth. The subledger journal entries 130 may be used to generate entries for a general ledger 140. General ledger journal entries 140 may reflect business or accounting data for an organization or site as a whole, while subledger journal entries 130 may be more specific to a particular organization division, or topic area. Further, subledger journal entries 130 and general ledger journal entries 140 may record measurements using different dimensions according to their purposes.

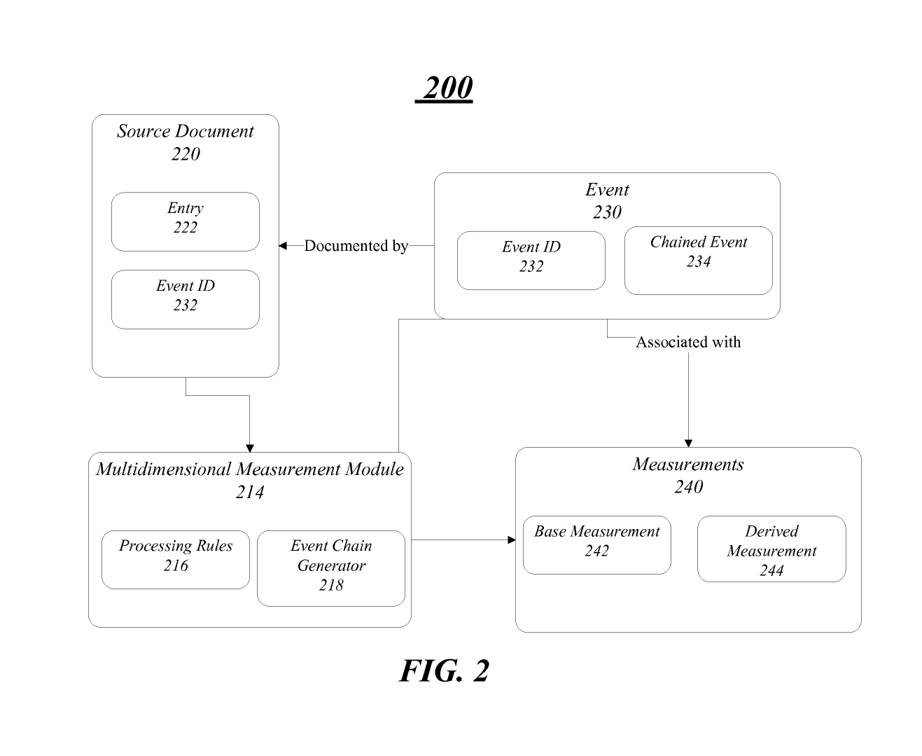

FIG. 2 illustrates a block diagram 200 representing an embodiment of an operation of accounting system 100. Block diagram 200 includes a multidimensional measurement module 214 and a source document 220, which may be representative examples of multidimensional measurement module 114 and source document 120, respectively.

Multidimensional measurement module (MMM) 214 may process data from source document 220 and generate an event 230 and measurements 240. Source document 220 may be, for example, a purchase order. Source document 220 may include various fields for data insertion, such as entry 222. For a purchase order, entry 222 could be a product quantity or a purchase unit price for an item being purchased. Source document 220 may include more or fewer entries. When a user creates a source document, the data associated with the document may be submitted to an accounting system for processing and approval. Source document 220 may include a reference to the event 320 that it is associated with. For example, event 230 may include an event identifier (ID) 232, and source document 220 may include a link, field, or other reference to event ID 232. In some embodiments, the data from entry 222, and measurements 240, may be written to a data store, e.g. in a database or a table in data store 116. MMM 214 may read the data from the data store. In other embodiments, the data may alternatively, or additionally, be delivered directly to MMM 214.

MMM 214 may generate event 230 according to the source document 220. For example, for a purchase order document, MMM 214 may create a purchase event. Each event 230 may be identified with an event identifier (ID) 232, analogously to the way that a specific purchase order may have a document identification number. In an embodiment, an event 230 may be an object instantiated from an event class.

An event 230 may have measurements 240 associated therewith. Measurements 240 may include one or more base measurements 242, and/or one or more derived measurements 244. A base measurement 242 may be a multidimensional measurement that characterizes an event. For a purchase order, the base measurements may be purchase quantity and unit price. Each measurement may have multiple dimensions. For example, one dimension of a purchase quantity measurement measures the counted pieces being sold, while another dimension includes the type of the product. A unit price measurement may have the dimensions of currency and product, e.g. U.S. dollars/case.

A derived measurement 244 may be a multidimensional measurement that is not immediately captured from the source document, but that can be calculated or looked up from the base measurement 242. A derived measurement 244 may be calculated from a formula or equation. For example, an extended price may be calculated from the equation of (purchase quantity×unit price), e.g. the extended price. The embodiments are not limited to these examples.

An event 230 may have consequences in the form of a chained event 234. A chained event 234 may be an event that occurs as a consequence of a first event or that is otherwise related to an event. Chained events 234 may import or otherwise include some or all of base measurements 232 and/or derived measurements 234. Examples of chained events will be discussed further with respect to later figures. A chained event 236 may have its own event ID, and may include a reference to the specific event that generated the chained event, referred to as the parent or causal event. For example, the chained event may include a reference to the event ID of the parent event. The embodiments are not limited to these examples.

In various embodiments, MMM 214 may make use of processing rules 216. Processing rules 216 may include, for example, accounting system rules that define events, relationships between and among events, measurements and/or dimensions that to be made and recorded, for example to comply with regulation, and so forth. In an embodiment, MMM 214 may generate an event 230 and its components from a source document 220 in accordance with one or more processing rules 216. In an embodiment, processing rules 216 may be based on multidimensional measurements and events, rather than on source documents.

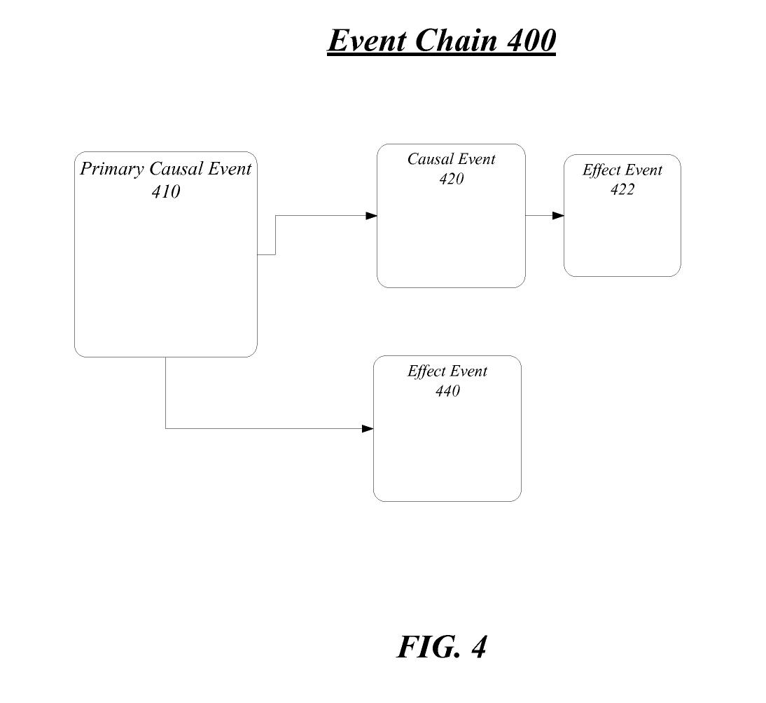

In various embodiments, MMM 214 may include an event chain generator 218. Event chain generator 218 may link derived measurements to base measurements and/or other derived measurements. Event chain generator 218 may connect specific related events 230 into an event chain. Business interactions typically involve a series of transactions or process steps, which may be represented by an event chain. Conventional accounting systems typically capture data relating to those transactions and steps in various source documents. An event chain, such as event 400 may provide a more complete picture of the series by capturing not just document-related measurements, but also multidimensional measurements that describe social, operational, and financial consequences of the events. An event chain may be added to as the related events are generated. An example of a measurement chain is described with respect to FIG. 4. An example of an event chain is described with respect to FIG. 4.

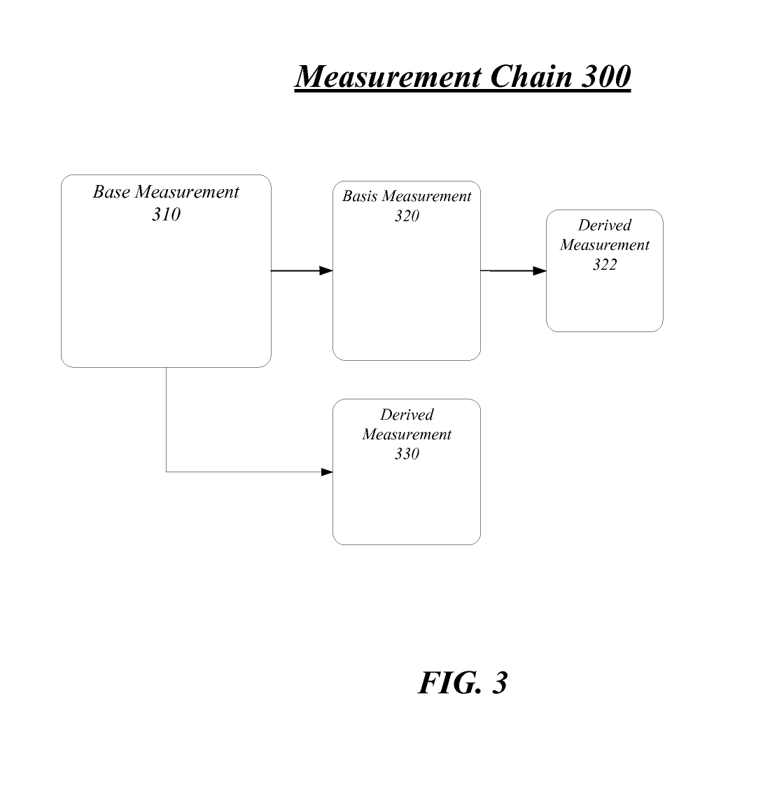

FIG. 3 illustrates a block diagram representing a measurement chain 300 for accounting system 100. Measurement chain 300 may be generated by MMM 214 when a derived measurement 244 is calculated. A measurement chain, such as measurement chain 300, may have one or more primary base measurements 310 that may represent the one or more base measurements of an event. The primary base measurements 310 may have one or more derived measurements. In an embodiment, a derived measurement may act as a base measurement for another derived measurement, and may be referred to as a “basis measurement”. For example, basis measurement 320 may be derived measurement from primary base measurement 310, and also be a base measurement for derived measurement 322. Derived measurement 330 may not have any further measurements that derive from it. Although the illustrated measurement chain 300 has four measurements, other measurement chains may have more or fewer measurements. Further, although measurement chain 300 is represented visually as linked measurements, the various measurements that make up measurement chain 300 may be coupled to each other in several different ways. Measurement chain 300 could be, for example, a list, a linked list, a set, an array, a tree, and so forth. A measurement chain may, for example, link an extended price derived measurement to the basis purchase quantity and purchase unit price measurements. Similarly, a measurement chain may, for example, link scheduled quantity and cash payment measurements. The embodiments are not limited to these examples.

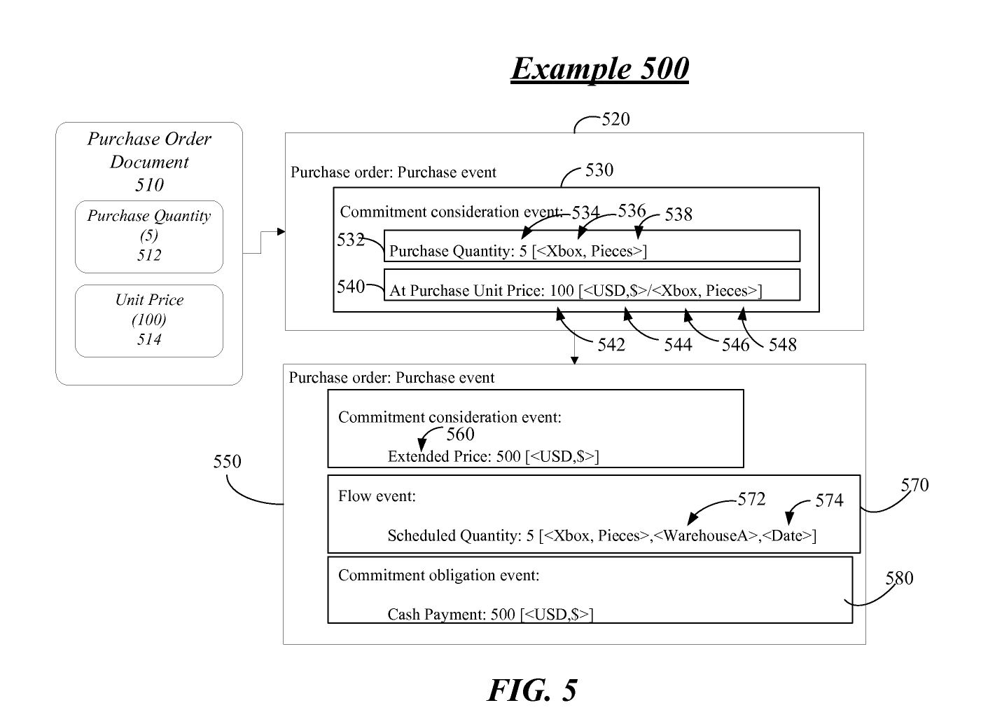

FIG. 4 illustrates a block diagram representing an event chain 400 for accounting system 100. Event chain 400 may be generated by MMM 214 when a new event 230 is generated at the beginning of a process, or when an event related to a first event of a process is generated. An event chain, such as event chain 400, may have a primary causal event 410 that may represent the first event of a process or series of transactions. The primary causal event 410 may have one or more effect events, also referred to as chained events. In an embodiment, an effect event may also be a causal event for still another effect event. For example, causal event 420 may be an effect event for primary causal event 410, and also be a causal event for effect event 422. Effect event 430 may not have any further effect events. Although the illustrated event chain 400 has four events, other event chains may have more or fewer events. Further, although event chain 400 is represented visually as linked elements, the various events that make up event chain 400 may be coupled to each other in several different ways. Event chain 400 could be, for example, a list, a linked list, a set, an array, a tree, and so forth. The embodiments are not limited to these examples. An example of an event chain 400 is discussed further with respect to FIG. 5.

FIGS. 5-7 illustrate the techniques described herein in use in the context of a specific example. In FIG. 5, a purchase order document 510 is generated in an accounting system. The entries for purchase quantity 512 and unit price 514 are filled in. MMM 214 receives the data from the entries 512 and 514 and generates a purchase event 520 from the purchase order.

Purchase event 520 includes a chained event, which is a commitment consideration event 530 in this example. Commitment consideration event 530 includes two base measurements: purchase quantity 532 (5) and purchase unit price 540 (100/unit). Purchase quantity 532 includes a magnitude 534 of “5”, and two resource dimension units product unit 536 and purchasing unit 538, “XBOX®” and “Pieces”, respectively. Purchase unit price 540 has a magnitude 542 of “100” and two quantity dimension units: dollars and purchasing unit. The multiple dimension units of the measurement are indicated by dimension 544 as U.S. dollars currency unit (USD) and a currency denomination dimension unit “$” (not labeled). The unit portion of the “unit price” is indicated by the dimension units 546 and 548, which reflect the dimension units from the purchase quantity of product type 536 and purchasing unit description 538. Thus, purchase unit price 540 for this purchase event 520 may be represented as “$100/Piece” or “100USD/XBOX®”

Once the base measurements are defined for purchase event 520, derived measurements are calculated by MMM 214. The purchase event 520 is updated to include the derived measurements as shown in updated purchase event 550. Commitment consideration event 530 has a derived measurement of extended price 560. An example of an equation for deriving the extended price of a purchase is “Extended price=Purchase Quantity*Purchase Unit Price”.

Purchase order document 510 may have additional consequences, reflected in this example in two additional events captured at the derived measurement calculation. First, a flow event 570 may reflect the movement or shipment of the purchased units from their location on a specific date. Flow event 570 may have a derived measurement of “scheduled quantity,” which may be calculated using the following equation “Scheduled Quantity=sum (Purchase Quantity).” In this example, the scheduled quantity includes a dimension that characterizes the location 572 of the activity that will generate a scheduled event, and the date 574 at which that activity is scheduled to occur.

Second, a commitment obligation event 580 may reflect the cash payment that the purchaser will be expected to pay for the purchased items. The cash payment consequence may be calculated using the following equation “Cash Payment=sum(Extend Price) for all purchased products”.

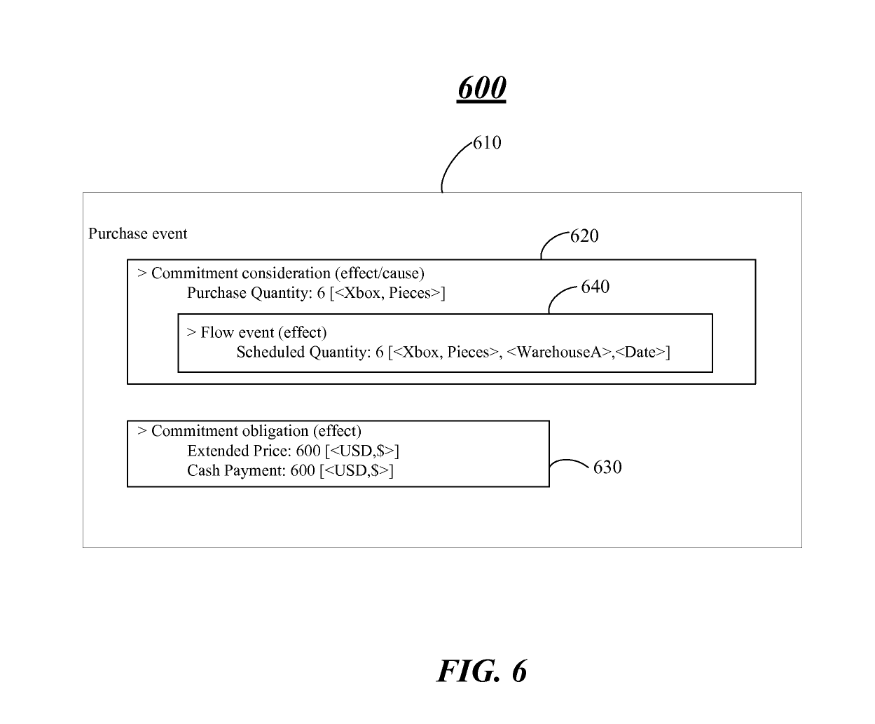

In FIG. 6, an event chain 610 may be generated by event chain generator 218 from the purchase order document 510 and the purchase event 550. Event chain 610 may link causal events (and their measure consequences) with effect events (and their consequences). For example, a purchase event represented by event chain 610 may be the cause of commitment consideration event 620 and commitment obligation event 630. Commitment obligation event 620 may be the cause of flow event 640. Later, when a payment is made, that payment event may be added to event chain 610 as well.

It is worthy to note that event chain 610, and its constituent events are all generated and derived from, in this example, a single source document. The events in event chain 610 are linked together, but do not need to refer to any specific source document numbers. Data about what is being purchased, how much is being purchased, the price of each unit, the extended price of the purchase, how much cash will be needed to pay for the purchase, where the units will flow from (or to), and when are all captured or derived from the one purchase event. The data is further captured in multiple dimensions, allowing it to be used by various aspects of an accounting system having an implementation independent of the multidimensional measurement basis.

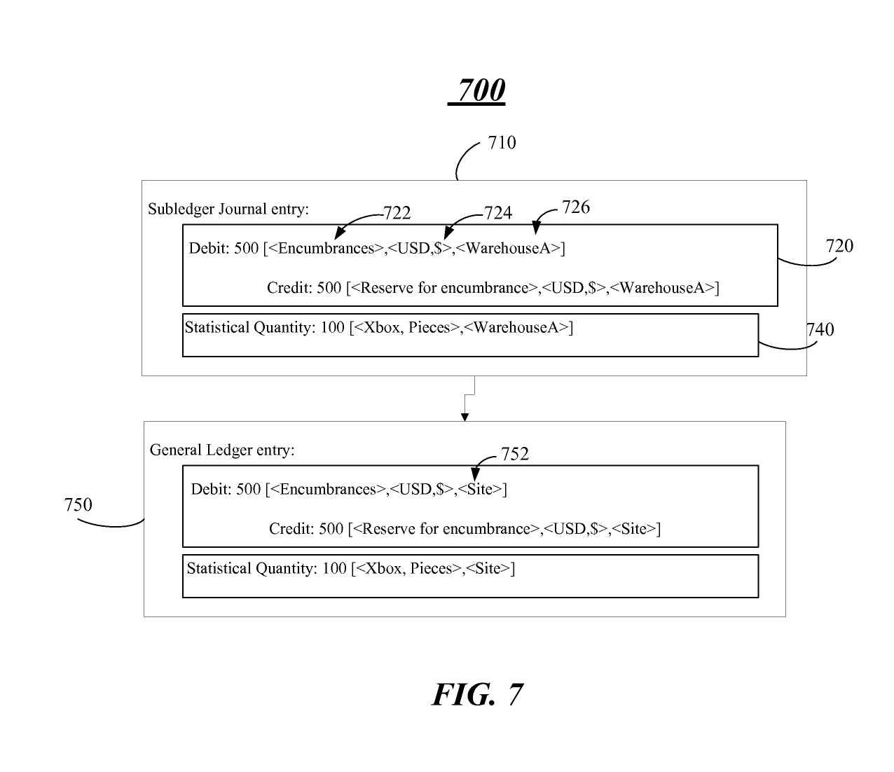

In FIG. 7, MMM 214 may have applied processing rules 216 to the base and derived measurements in event chain 610 to generate a subledger journal entry 710. Subledger journal entry 710 may be an example of a debit and credit account entry. Processing rules 216 may specify, for example, what types of entries need to be made into a particular subledger journal, what measurements should be included, how to calculate the measurements, and so forth. In this example, a valuation measurement 720 that is encumbered may be characterized by an encumbrance (budget fund reservation) activity dimension unit 722 as well as a currency dimension unit 724, and an operational location (site) dimension unit 726. The statistical quantity 740 recorded as part of subledger journal entry 710 is a derived measurement for reporting an encumbrance in proportion to the quantity of XBOX® piece units stored at warehouse location units.

MMM 214 may then use subledger journal entry 710 to generate a general ledger journal entry 750. General ledger journal entry 750 may be generated from subledger journal entry 710. In general ledger journal entry 750, the location dimension 752 may be summarized to the level of the site at which multiple warehouses are located. When the purchase event affects multiple warehouses, a different subledger journal entry may exist for each affected warehouse. The general ledger journal entry would then reflect a summation of all of the units sold across the multiple warehouses. For example, if 10 units were purchased, and 6 units were going to warehouse A and 4 were going to warehouse B, the subledger journal entry for warehouse A (or B) would look like subledger journal entry 710. General ledger journal entry 750, however would reflect a Debit entry of $1000=($100×6 units from warehouse A)+($100×4) units from warehouse B). However, because this example has shown only one location, the summarized number recorded in the general ledger journal entry 750 is the same as the number recorded in the subledger journal entry 710.

The example application of the multi-dimensional measurement basis accounting system illustrated by FIGS. 4-6 may be extended to many other events that characterize transactions, processes and/or regulatory requirements within an accounting system. The embodiments are not limited to these examples.

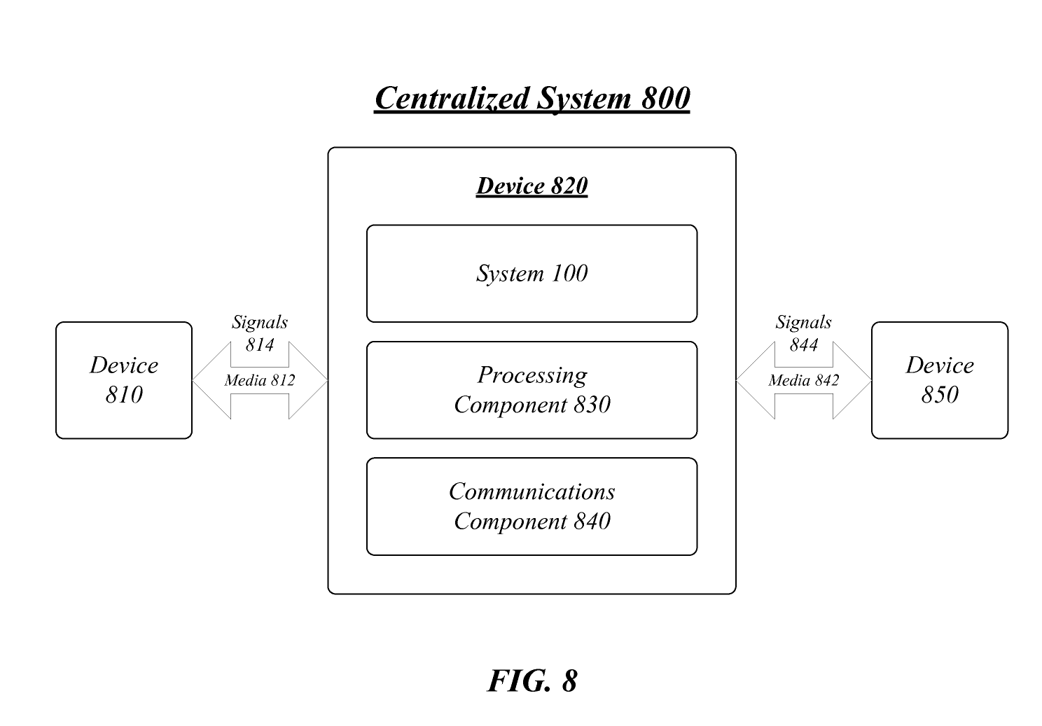

FIG. 8 illustrates a block diagram of a centralized system 800. The centralized system 800 may implement some or all of the structure and/or operations for the accounting system 100 in a single computing entity, such as entirely within a single device 820.

The device 820 may comprise any electronic device capable of receiving, processing, and sending information for the accounting system 100. Examples of an electronic device may include, without limitation, an ultra-mobile device, a mobile device, a personal digital assistant (PDA), a mobile computing device, a smart phone, a telephone, a digital telephone, a cellular telephone, ebook readers, a handset, a one-way pager, a two-way pager, a messaging device, a computer, a personal computer (PC), a desktop computer, a laptop computer, a notebook computer, a netbook computer, a handheld computer, a tablet computer, a server, a server array or server farm, a web server, a network server, an Internet server, a work station, a mini-computer, a main frame computer, a supercomputer, a network appliance, a web appliance, a distributed computing system, multiprocessor systems, processor-based systems, consumer electronics, programmable consumer electronics, game devices, television, digital television, set top box, wireless access point, base station, subscriber station, mobile subscriber center, radio network controller, router, hub, gateway, bridge, switch, machine, or combination thereof. The embodiments are not limited in this context.

The device 820 may execute processing operations or logic for the accounting system 100 using a processing component 830. The processing component 830 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 820 may execute communications operations or logic for the accounting system 100 using communications component 840. The communications component 840 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 840 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 812, 842 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 820 may communicate with other devices 810, 850 over a communications media 812, 842, respectively, using communications signals 814, 844, respectively, via the communications component 840. The devices 810, 850 may be internal or external to the device 820 as desired for a given implementation. In an embodiment, for example, device 820 may include instructions that when executed operate accounting system application 110. In an embodiment, device 820 may include instructions that when executed operate components of accounting system 110, such as multidimensional measurement module 114, 214, and/or event chain generator 216.

Devices 810, 850 may represent client devices that communicate with accounting system application 110 on device 820, for example, to create and complete a source document according to user directives received at devices 810, 850, and/or to generate or display subledger and general ledger journal entries. Devices 810, 850 may represent business partner devices that may have access to some aspects of accounting system application 110, for example, in a supplier/manufacturer relationship.

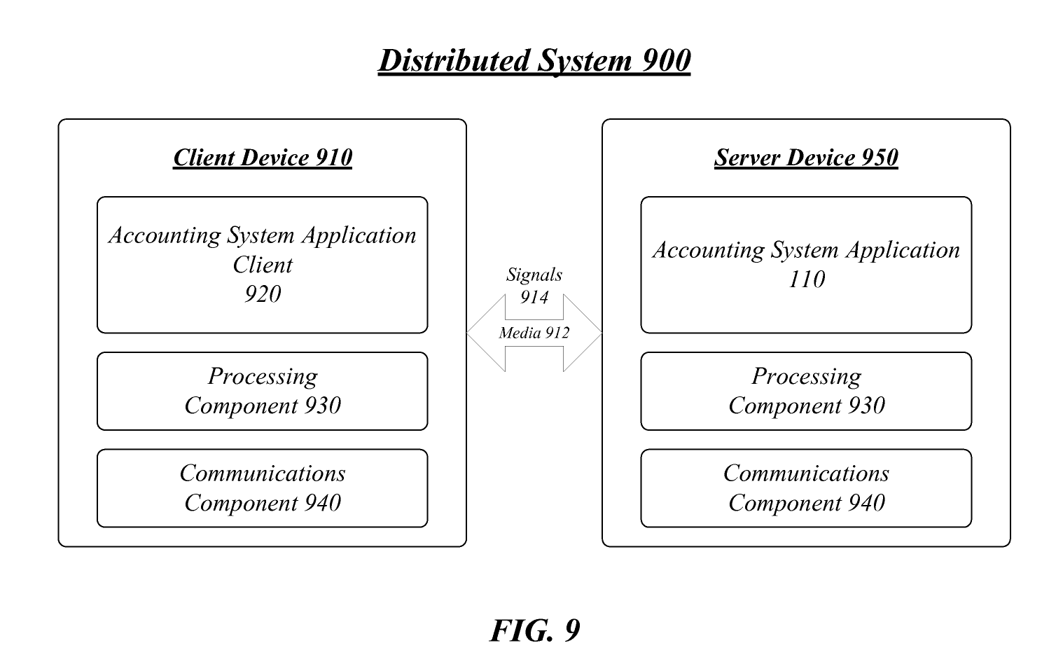

FIG. 9 illustrates a block diagram of a distributed system 900. The distributed system 900 may distribute portions of the structure and/or operations for the accounting system 100 across multiple computing entities. Examples of distributed system 900 may include without limitation a client-server architecture, a 4-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 900 may comprise a client device 910 and a server device 950. In general, the client device 910 and the server device 950 may be the same or similar to the device 820 as described with reference to FIG. 8. For instance, the client system 910 and the server system 950 may each comprise a processing component 930 and a communications component 940 which are the same or similar to the processing component 830 and the communications component 840, respectively, as described with reference to FIG. 8. In another example, the devices 910, 950 may communicate over a communications media 912 using communications signals 914 via the communications components 940.

The client device 910 may comprise or employ one or more client programs that operate to perform various methodologies in accordance with the described embodiments. In one embodiment, for example, the client device 910 may implement an accounting system application client 920. Accounting system application client 920 may provide, for example, user interfaces to allow a user to interact with accounting system application server 110, for example, by entering data, retrieving data, operating on data and so forth. Accounting system application client 920 may further provide some accounting system related functions locally at client device 910. The embodiments are not limited to these examples.

The server device 950 may comprise or employ one or more server programs that operate to perform various methodologies in accordance with the described embodiments. In one embodiment, for example, the server device 950 may implement accounting system application 110. In an embodiment, server device 950 may be implemented by multiple physical devices, as in a cloud computing environment. Functional portions of accounting system application server 110 may be distributed among two or more devices. Data stored and operated on by accounting system application server 110 may also be stored in a distributed manner.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

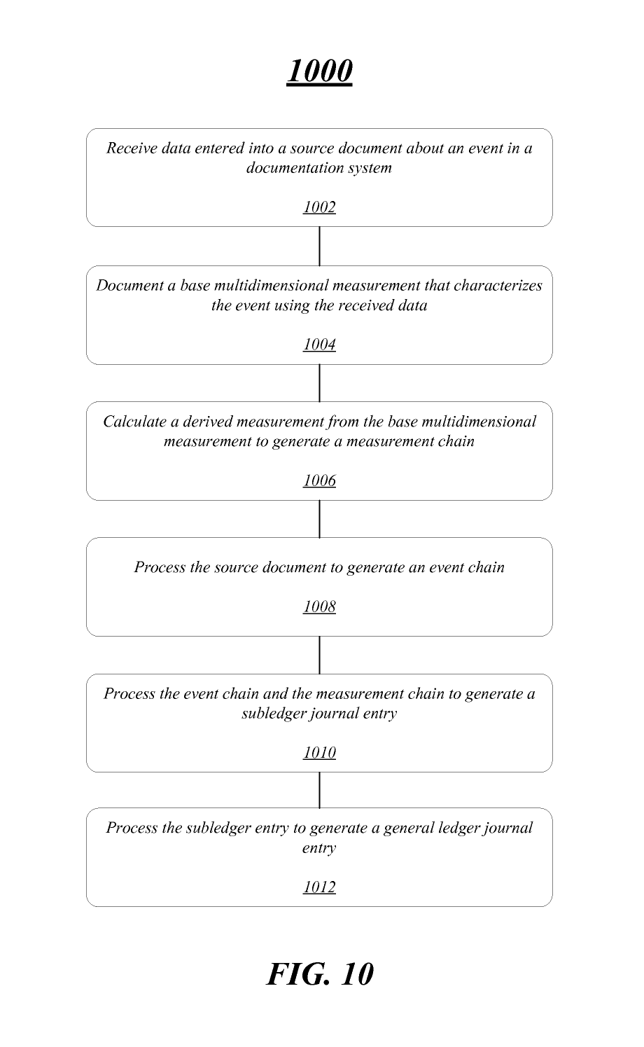

FIG. 10 illustrates one embodiment of a logic flow 1000. The logic flow 1000 may be representative of some or all of the operations executed by one or more embodiments described herein.

In the illustrated embodiment shown in FIG. 10, the logic flow 1000 receives data entered into a source document about an event in a documentation system at block 1002. For example, multidimensional measurement module 114 executing as part of accounting system application server 110 may receive data from entries 222, 224 in a source document 220. The source document may be related to a transaction or a process step, which may be represented as an event.

The logic flow 1000 may document a base multidimensional measurement that characterizes the event using the received data at block 1004. For example, an event 230 may include a base measurement 242 as a variable, whose value is sent from data received from the source document 220. In an embodiment, while the source document may reflect one dimension, the base measurement of the associated event may capture multiple dimensions for the base measurement. MMM 114, 214 may instantiate an event object according to the source document type, and assign the base measurement variable values according to the data received. In an embodiment, a source document may include entries related to multiple events, causing several events to be generated.

The logic flow 1000 may calculate a derived measurement from the base multidimensional measurement at block 1006 and generate a measurement chain linking the base and derived measurements. For example, MMM 114, 214 may evaluate various equations or formulas, or look up value in a table or database, from the base measurement(s). In an embodiment, an event object may further include derived measurement variables whose values are assigned according to the calculation. The base measurements and derived measurements may be linked together in a measurement chain, such as measurement chain 300.

The logic flow 1000 may process the source document to generate an event chain at block 1008. For example, using event chain generator 218, MMM 214 may link together events having a cause and effect relationship. Each event may include a reference to its causal event, its effect event or both. New effect events may be generated as part of the event chain. An event may include instructions to generate effect events.

The logic flow 1000 may process the measurement chain and event chain to generate a subledger journal entry at block 1010. For example, MMM 214 may read processing rules 216 to determine what entries are needed for a particular subledger, including the values and their dimensions. In an embodiment, the processing rules 216 are constructed with reference to events and/or measurements, both base and derived, and may not refer to any particular source document. The processing rules 216 may state what measurements to retrieve or calculate from the events in an event chain. Generating a subledger journal entry may also include generating statistical information that may, for example, facilitate compliance with regulations and policies.

The logic flow 1000 may process the subledger journal entry to generate a general ledger journal entry at block 1012. For example, MMM 214 may aggregate related subledger entries, such as entries about one event from a fixed assets subledger journal, a cost subledger journal, and a purchase subledger journal, to create a general ledger journal entry. Because the subledgers all share the same multidimensional measurement basis, data collection may be more efficient. Generating a general ledger journal entry may also include generating statistical information that may, for example, facilitate compliance with regulations and policies.

In various embodiments, some blocks in logic flow 1000 may be optional, and others may be performed more than once, for a given set of transactions or process steps. The embodiments are not limited to this example.

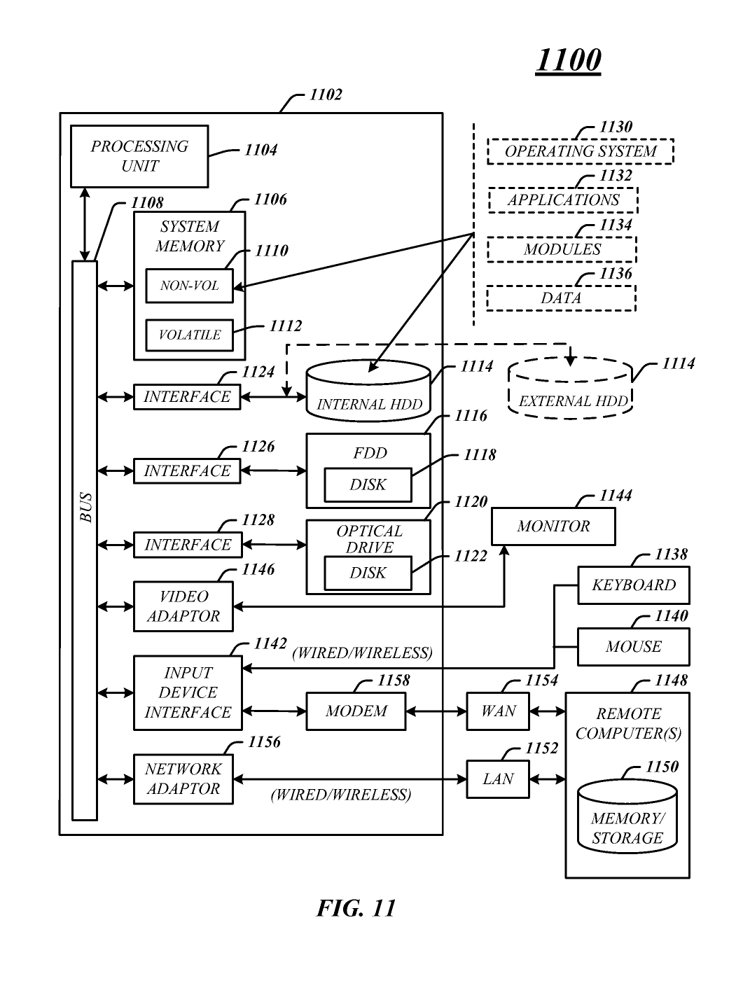

FIG. 11 illustrates an embodiment of an exemplary computing architecture 1100 suitable for implementing various embodiments as previously described. In one embodiment, the computing architecture 1100 may comprise or be implemented as part of an electronic device. Examples of an electronic device may include those described with reference to FIG. 8, among others. The embodiments are not limited in this context.

As used in this application, the terms “system” and “component” are intended to refer to a computer-related entity, either hardware, a combination of hardware and software, software, or software in execution, examples of which are provided by the exemplary computing architecture 1100. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 1100 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 1100.

As shown in FIG. 11, the computing architecture 1100 comprises a processing unit 1104, a system memory 1106 and a system bus 1108. The processing unit 1104 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1104.

The system bus 1108 provides an interface for system components including, but not limited to, the system memory 1106 to the processing unit 1104. The system bus 1108 can be any of several types of bus structure that may further interconnect to a memory bus (with or without a memory controller), a peripheral bus, and a local bus using any of a variety of commercially available bus architectures. Interface adapters may connect to the system bus 1108 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 1100 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a computer-readable storage medium, which may be read and executed by one or more processors to enable performance of the operations described herein.

The system memory 1106 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 11, the system memory 1106 can include non-volatile memory 1110 and/or volatile memory 1112. A basic input/output system (BIOS) can be stored in the non-volatile memory 1110.

The computer 1102 may include various types of computer-readable storage media in the form of one or more lower speed memory units, including an internal (or external) hard disk drive (HDD) 1114, a magnetic floppy disk drive (FDD) 1116 to read from or write to a removable magnetic disk 1118, and an optical disk drive 1120 to read from or write to a removable optical disk 1122 (e.g., a CD-ROM or DVD). The HDD 1114, FDD 1116 and optical disk drive 1120 can be connected to the system bus 1108 by a HDD interface 1124, an FDD interface 1126 and an optical drive interface 1128, respectively. The HDD interface 1124 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 1110, 1112, including an operating system 1130, one or more application programs 1132, other program modules 1134, and program data 1136. In one embodiment, the one or more application programs 1132, other program modules 1134, and program data 1136 can include, for example, the various applications and/or components of the accounting system 110.

A user can enter commands and information into the computer 1102 through one or more wire/wireless input devices, for example, a keyboard 1138 and a pointing device, such as a mouse 1140. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1104 through an input device interface 1142 that is coupled to the system bus 1108, but can be connected by other interfaces such as a parallel port, IEEE 1394 serial port, a game port, a USB port, an IR interface, and so forth.

A monitor 1144 or other type of display device is also connected to the system bus 1108 via an interface, such as a video adaptor 1146. The monitor 1144 may be internal or external to the computer 1102. In addition to the monitor 1144, a computer typically includes other peripheral output devices, such as speakers, printers, and so forth.

The computer 1102 may operate in a networked environment using logical connections via wire and/or wireless communications to one or more remote computers, such as a remote computer 1148. The remote computer 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wire/wireless connectivity to a local area network (LAN) 1152 and/or larger networks, for example, a wide area network (WAN) 1154. Such LAN and WAN networking environments are commonplace in offices and companies, and facilitate enterprise-wide computer networks, such as intranets, all of which may connect to a global communications network, for example, the Internet.

When used in a LAN networking environment, the computer 1102 is connected to the LAN 1152 through a wire and/or wireless communication network interface or adaptor 1156. The adaptor 1156 can facilitate wire and/or wireless communications to the LAN 1152, which may also include a wireless access point disposed thereon for communicating with the wireless functionality of the adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wire and/or wireless device, connects to the system bus 1108 via the input device interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

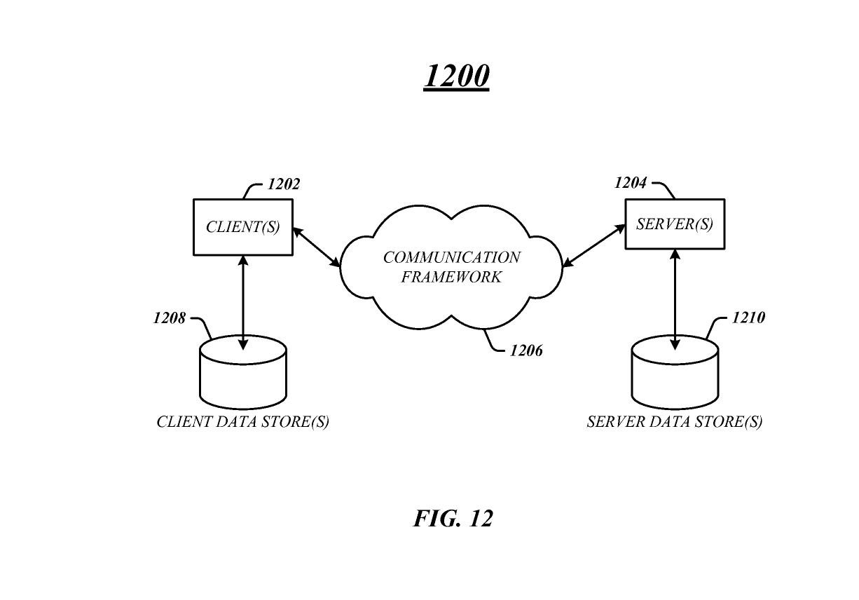

FIG. 12 illustrates a block diagram of an exemplary communications architecture 1200 suitable for implementing various embodiments as previously described. The communications architecture 1200 includes various common communications elements, such as a transmitter, receiver, transceiver, radio, network interface, baseband processor, antenna, amplifiers, filters, power supplies, and so forth. The embodiments, however, are not limited to implementation by the communications architecture 1200.

As shown in FIG. 12, the communications architecture 1200 comprises includes one or more clients 1202 and servers 1204. The clients 1202 may implement the client device 910. The servers 1204 may implement the server device 950. The clients 1202 and the servers 1204 are operatively connected to one or more respective client data stores 1208 and server data stores 1210 that can be employed to store information local to the respective clients 1202 and servers 1204, such as cookies and/or associated contextual information.

The clients 1202 and the servers 1204 may communicate information between each other using a communication framework 1206. The communications framework 1206 may implement any well-known communications techniques and protocols. The communications framework 1206 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1206 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth needed by clients 1202 and the servers 1204. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes examples of the disclosed architecture. It is, of course, not possible to describe every conceivable combination of components and/or methodologies, but one of ordinary skill in the art may recognize that many further combinations and permutations are possible. Accordingly, the novel architecture is intended to embrace all such alterations, modifications and variations that fall within the spirit and scope of the appended claims.

1. An apparatus, comprising:
a processing component; and
multidimensional measurement module operative on the processing component to document a base multidimensional measurement that characterizes an event using data received from a source document, calculate a derived measurement from the base multidimensional measurement to generate a measurement chain, process the source document to generate an event chain, and process the measurement chain and event chain to generate a subledger journal entry.

2. The apparatus of claim 1, the multidimensional measurement module operative to process the subledger journal entry to generate a general ledger journal entry.

3. The apparatus of claim 1, the multidimensional measurement module operative to: generate a subledger journal entry by executing processing rules on measurements in the measurement chain and events in the event chain.

4. The apparatus of claim 4, wherein a processing rule is based on an event.

5. The apparatus of claim 4, wherein a processing rule is based on a multidimensional measurement.

6. The apparatus of claim 1, wherein an event includes a chained event.

7. The apparatus of claim 1, wherein an event includes a derived measurement defined according to at least one base multidimensional measurement.

8. A computer-implemented method, comprising:
receiving data entered into a source document about an event in a documentation system;
documenting a base multidimensional measurement that characterizes the event using the received data;
calculating a derived measurement from the base multidimensional measurement to generate a measurement chain;
processing the source document to generate an event chain;
processing the measurement chain and the event chain to generate a subledger journal entry; and
processing the subledger journal entry to generate a general ledger journal entry.

9. The computer-implemented method of claim 8, wherein an event comprises an event identifier (ID), the method comprising: generating an event chain by linking a causal event and a measure consequence of the causal event to an effect event and a measure consequence of the effect event, using the event IDs for each of the causal event and effect event.

10. The computer-implemented method of claim 8, comprising generating a subledger journal entry by executing processing rules on measurements and events in the event chain.

11. The computer-implemented method of claim 8, comprising generating a plurality of events from the received data.

12. The computer-implemented method of claim 11, wherein at least one of the plurality of events is a chained event of another of the plurality of events.

13. The computer-implemented method of claim 8, calculating statistical information from the multidimensional measurements in the event chain.

14. The computer-implemented method of claim 8, comprising: generating a new effect event as part of generating the event chain.

15. At least one computer-readable storage medium comprising instructions that, when executed, cause a system to:
document a base multidimensional measurement that characterizes an event using data received from a source document;
calculate a derived measurement from the base multidimensional measurement to generate a measurement chain;
process the source document to generate an event chain;
process the event chain to generate a subledger journal entry; and
process the subledger journal entry to generate a general ledger journal entry.

16. The computer-readable storage medium of claim 15, comprising instructions that when executed cause the system to: generate an event chain by linking a causal event and a measure consequence of the causal event to an effect event and a measure consequence of the effect event.

17. The computer-readable storage medium of claim 15, comprising instructions that when executed cause the system to: generate a subledger journal entry by executing processing rules on measurements and events in the event chain.

18. The computer-readable storage medium of claim 17, comprising instructions that when executed cause the system to: wherein a processing rule is based on at least one of: an event and a multidimensional measurement.

19. The computer-readable storage medium of claim 15, comprising instructions that when executed cause the system to: calculate statistical information from the multidimensional measurements in the event chain

20. The computer-readable storage medium of claim 15, comprising instructions that when executed cause the system to: generate the general ledger journal entry from the aggregation of a plurality of subledger journal entry.
